(19) United States
(12) Patent Application Publication
(10) Pub. No.: US 2013/0222551 A1
(43) Pub. Date: Aug. 29, 2013

(54) MAPPING DETECTING AND TRACKING OBJECTS IN AN ARBITRARY OUTDOOR SCENE USING ACTIVE VISION

(71) Applicants: Hanan Shamir, Binyamina (IL); Lior Barak, Binyamina (IL); Roy Israeli, Haifa (IL)

(72) Inventors: Hanan Shamir, Binyamina (IL); Lior Barak, Binyamina (IL); Roy Israeli, Haifa (IL)

(21) Appl. No.: 13/878,231

(22) PCT Filed: Oct. 4, 2011
(86) PCT No.: PCT/IB11/54353

§ 371 Date: Apr. 8, 2013

(30) Foreign Application Priority Data
Oct. 7, 2010 (IL) 208568

(51) Int. Cl. G01B 11/25; H04N 13/02

(52) U.S. Cl. CPC G01B 11/2513; H04N 13/0271
USPC 348/47

(57) ABSTRACT

An active vision based method and system for video capturing is provided herein. The method may include the following steps: illuminating a stationary outdoor scene containing objects, with a structured light exhibiting a specified pattern, at a first angle; capturing reflections from the objects in the stationary scene, in a second angle, the reflections exhibiting distortions of the specified pattern; analyzing the reflected distortions of the specified pattern, to yield a three dimensional model of the stationary scene containing the objects, wherein the specified pattern may include temporal and spatial modulation.

### BACKGROUND

1. Technical Field

The present invention relates to the field of video capturing in an arbitrary scene. More specifically, embodiments of the invention relate to structured light active vision that may be implemented, for example, by non-short wave continuous Infra Red light.

2. Discussion of the Related Art

Low visibility conditions such as in harsh weather or during the night, pose an ongoing challenge to visual surveillance system such as video surveillance and closed circuit television (CCTV). The use of active vision to overcome low visibility is known in the art. So is the use of structured light in which the light used for illuminating is known in terms of geometry and physical properties. However, structured light has not been yet in use in the video surveillance domain which is characterized by an arbitrary outdoor scene.

### BRIEF SUMMARY

One aspect of the invention provides a method of video capturing. The method may include the following steps: illuminating an outdoor scene containing objects, with a structured light exhibiting a specified pattern, at a first angle; capturing reflections from the objects in the scene, in a second angle, the reflections exhibiting distortions of the specified pattern; analyzing the reflected distortions of the specified pattern, to yield a three dimensional model of the scene containing the objects, wherein the specified pattern may comprise temporal modulation.

Then repeating the illuminating, capturing and analyzing in different angles, wherein the analyzing is based at least partially on depth differences derived from the distorted reflection and further in view of the three dimensional model of the scene.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an aspect of a system consistent with an embodiment of the invention;

FIG. 2 is a high level schematic diagram illustrating an aspect of a system consistent with an embodiment of the invention;

FIG. 3 is a high level schematic diagram illustrating an aspect of a system consistent with an embodiment of the invention; and

FIG. 4 is a high level flowchart diagram illustrating an aspect of a method consistent with an embodiment of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “stationary scene” as used herein in this application refers to a scene, possibly but not necessarily an outdoor scene, that does not change over a specified period of time.

The term “structured light” as used herein in this application refers to a process of projecting a known pattern of pixels (often grids, horizontal bars, or vertical bars) onto a scene. The way that these deform when striking surfaces allows vision systems to calculate the depth and surface information of the objects in the scene, as used in structured light 3D scanners.

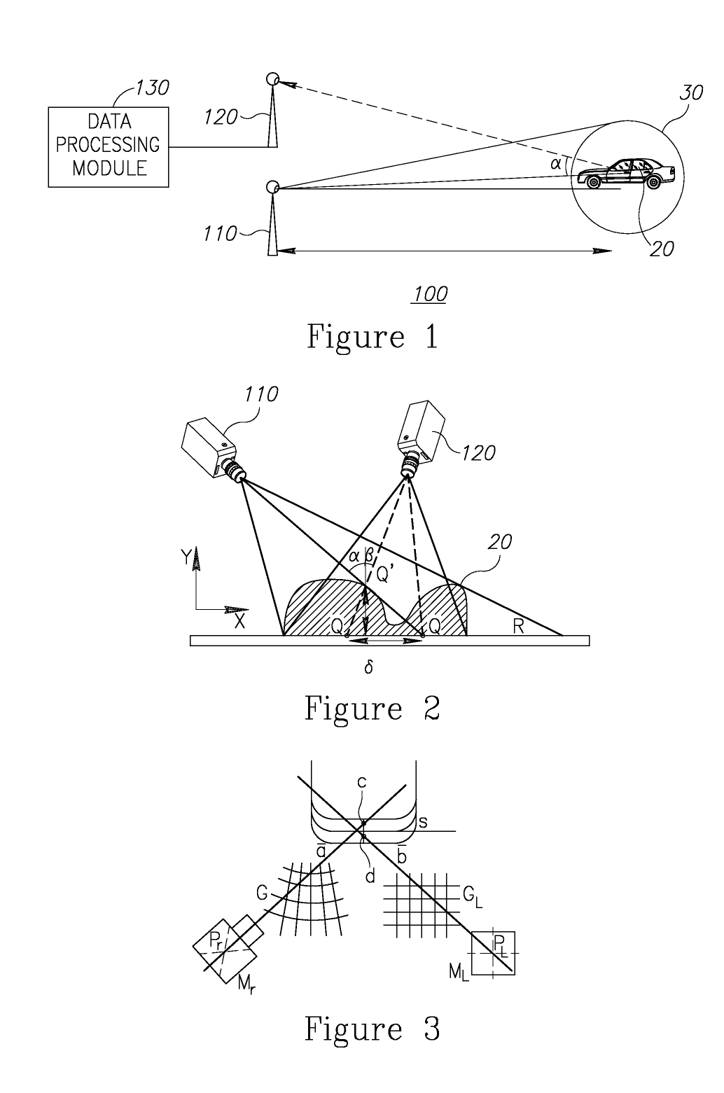

FIG. 1 is a high level schematic block diagram illustrating a system consistent with an embodiment of the invention. The system may include at least one light source 110 arranged to illuminate a specified area 30 of an outdoor scene containing at least one object 20, with structured light exhibiting a specified pattern, at a first angle. The system further includes at least one imaging device 120 arranged to capture reflections from the objects in the scene, in a second angle, the reflections exhibiting distortions or deformations of the specified pattern. The system may further include a data processing module 130 arranged to analyze the reflected distortions/deformations of the specified pattern, to yield a three dimensional model of the scene containing the objects. Specifically, the specified pattern may be achieved by temporal modulation so that the pattern changes over time. The aforementioned stage is referred to herein as a calibration stage in which the scene is analyzed as a stationary set of background and objects.

Consistent with one embodiment of the invention, and in order to provide adjustment functionalities as well as to address video surveillance needs, a pan/tilt/zoom (PTZ) module is further provided (not shown—embedded within light source 110). The PTZ module is in operative association with light source 110 or integrated therewith. PTZ module is configured to aim the light source towards a specified target selected from the objects within the scene, in response to a user selection. Additionally, the PTZ module is further configured to focus the pattern of the structured light projected upon the specified target. Thus, the PTZ module may be used to ensure that a valid pattern of structured light is projected at any given time upon the specified target of interest.

Consistent with one embodiment of the invention, light sources 110 may be further arranged to repeat the illuminating of the scene, this time with a specified pattern exhibiting spatial or spatiotemporal modulation. Similarly, imaging devices 120 are arranged to repeat the capturing, and data processing module 130 is further arranged to analyze the reflected distortions over time based on comparison to the stationary data derived the three dimensional model, to yield detection or tracking of non-stationary objects in the scene. The aforementioned feature may be referred herein as a data extraction stage.

Consistent with one embodiment of the invention, light sources 110 are further arranged to repeat the illuminating of the scene, this time with a specified pattern exhibiting spatial or spatiotemporal modulation. Similarly, imaging devices 120 are arranged to repeat the capturing. In addition, data processing module 130 is further arranged to analyze the reflected distortions by comparing geometrical features associated with the reflected distortion to respective geometrical features of other objects based on comparison to stationary data derived the three dimensional model, to yield classification of objects in the scene. The aforementioned feature may also be referred herein as a data extraction stage.

Consistent with one embodiment of the invention, the system comprises one or more structured light sources located at a specified angle to one or more respective imaging devices. A data processing module 130 is in operative association with the light sources and the imaging devices. In operation, the light sources and the imaging devices are directed at a scene for which no prior knowledge is provided. The light sources are configured to emit structured light exhibiting a specified pattern. Accordingly, the imaging devices are configured to detect reflection from the scene exhibiting the specified pattern.

Since no prior knowledge regarding the scene is provided, the aforementioned calibration stage is required. In the calibration stage, a three dimensional model of the scene is prepared. According to some embodiments, this is achieved, for a stationary scene, by applying via the structured light sources, a temporally modulated light pattern over a specified period of time throughout the scene. It is being noted that the shape of the light pattern is being distorted (compared with the initial generated shape) as it strikes a three dimensional scenery background. Data processing module 130 analyses the corresponding reflections, generating three dimension background model according to the distortion pattern, taking into account the specific temporal modulation applied by the light sources.

The inventor has discovered that applying temporally modulated structured light in the calibration stage is advantageous (over spatial modulation, for example) since temporal modulation yields significantly better results in stationary scenes and in spatial step functions (step in distance range) within the scene (areas of discontinuity of the surface in the scene). The use of temporal modulation for the calibration stage is further advantageous as it enables to detect depth and not only the texture of surfaces within the scene. Another advantage of temporal modulation over spatial modulation in the calibration stage is that temporal modulation of the structured light eliminates the need for coding that is necessary in spatial modulation in order to differentiate between portions of the specified pattern of the structured light.

The three dimensional model of the scene achieved in the calibration stage serves as a frame of references for the data extraction stage in which a plurality of applications may be executed according to some embodiments of the invention. These applications may include detection of objects within the scene, classifying detected objects, and tracking detected object throughout the scene.

In the aforementioned data extraction stage spatially modulated light or tempo-spatially modulated light may be used as the specified pattern. For example, a grid or a mesh may be advantageous as it reduces the computational intensity required (a significantly smaller number of pixel are required for processing). It is noted that detection process of object and tracking its motion is performed through analysis of grid distortions compared with the initial referenced grid pattern (with the absence of the object). It is also noted that object classification may take advantage of three dimension object attributes which are calculated throughout the process of generating three dimension model of the object. Again three dimensional model of an object is calculated through an analysis of grid distortion.

According to some embodiments of the invention, the data extraction stage may be used in stereoscopic applications in conjunction with embodiments of the present invention. Advantageously, the prior knowledge of the pattern emitted by the light source may eliminate the need of aligning two imaged according to common points of reference as required in stereoscopic analysis. Specifically, the structured light, by virtue of its specified pattern used in the illuminating, provides an inherent points of reference un related to the image itself but to the specified patterns. Thus, aligning two images containing structured light is made easy.

According to some embodiments of the invention, various coding techniques may be employed in spatial modulation of the structured light in the data extraction stage. Exemplary coding may be using different colors for different lines on a grid, using orthogonal spatial frequency and the like.

According to other embodiments, when coding is not used, uniformity and continuity checks along grid lines (or other portion of the specified pattern) may be used in order to distinguish between grid lines (or other portion of the specified pattern) and may serve as a substitute for coding.

In some embodiments, the structured light sources may operate in cooperation with visible light and/or gated light techniques in order to increase the amount of data that may be derived from the scene. The structured light sources may be implemented with eye safe IR laser, for example in the 1.5 micrometer region.

According to some embodiments of the invention, on both stages (calibration and data extraction) the parallax that is due to the distance between the light sources and the imaging device is beneficial in at least two respects. First, the parallax enables depth analysis of the surfaces in the scene. Second, the parallax enables objects assignment and detection in relation to the background of the scene so that 3D conception of the scene is made possible.

FIG. 2 is a high level schematic diagram illustrating an aspect of a system consistent with an embodiment of the invention. Illuminating source 110 is directed at a specified angle α at object 20. Reflections are captured by imaging device 120 that is directed at angle β. Due to object 20, a projected point Q is diverged to Q′ and captured as Q″. Deriving the displacement between projection and reflection may be used to determine the depth difference of object 20 at any given point Q in regards with reference plan R. Thus, a depth—difference based analysis of the scene and its objects is achieved.

FIG. 3 is a high level schematic diagram illustrating an aspect of a system consistent with an embodiment of the invention. A specified pattern of structured light, such as grid GL is projected upon an object. Reflected grid GR exhibits the distortion due to the depth differences of the object. Analyzing these distortions is useable for deriving the depth difference mapping of the object and its background.

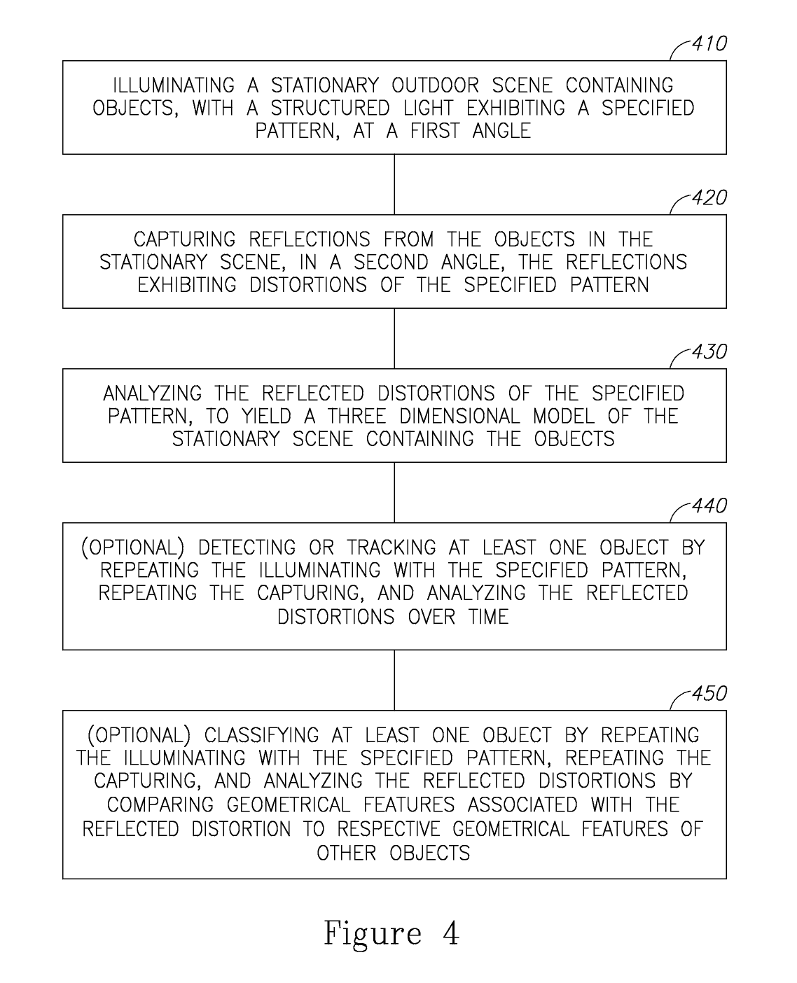

FIG. 4 is a high level flowchart diagram illustrating an aspect of a method consistent with an embodiment of the invention. The aforementioned system may be provided in other architectures than those described above. For the sake of generality, an algorithmic approach illustrates below how embodiments of the invention are implemented in an architecture independent manner. The method may include the following steps: illuminating a stationary outdoor scene containing objects, with a structured light exhibiting a specified pattern, at a first angle 410. The method goes on to capturing reflections from the objects in the stationary scene, in a second angle, the reflections exhibiting distortions of the specified pattern 420. Then, the method goes on to analyzing the reflected distortions of the specified pattern, to yield a three dimensional model of the stationary scene containing the objects, wherein the specified pattern may comprises temporal modulation.

Consistent with one embodiment of the invention, the method may further include the step of detecting or tracking at least one stationary or non-stationary object by repeating the illuminating with the specified pattern comprising spatial or spatiotemporal modulation, repeating the capturing, and analyzing the reflected distortions over time based on comparison to stationary data derived the three dimensional model, wherein the comparison is based at least partially on depth differences derived from the distorted reflections 440.

Consistent with one embodiment of the invention, the method may further include the step of classifying at least one object by repeating the illuminating with the specified pattern comprising spatial or spatiotemporal modulation, repeating the capturing, and analyzing the reflected distortions by comparing geometrical features associated with the reflected distortion to respective geometrical features of other objects based on comparison to stationary data derived the three dimensional model 450.

Advantageously, embodiments of the aforementioned method enable detection of camouflaged targets because it relies on 3D data fluctuations rather than on texture data. Specifically, the analysis of the distorted reflection is based on depth difference derived from the distorted reflections. These depth differences provide valuable information useable for distinguishing n object from its background.

Advantageously, embodiments of the aforementioned method can extract 3D information at very high accuracy, for example, at a resolution of few centimeters rather than tens of centimeters in stereoscopic method. This is achieved, among other things, due to the ease of aligning two images of the same scene, when structured light was used in capturing the images.

Advantageously, embodiments of the aforementioned method may be used to extract 3D information of a scene that is showing smooth and homogeneous surfaces without any points of interest to hold on (without distinguished texture). This is again due to the nature of images captured using structured light that enables high depth distinction (as opposed to texture distinction, for example).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention.

What is claimed is:

1. A method of video capturing comprising:
illuminating an outdoor scene containing objects, with a structured light exhibiting a specified pattern, at a first angle;
capturing reflections from the objects in the scene, in a second angle, the reflections exhibiting distortions of the specified pattern;
analyzing the reflected distortions of the specified pattern, to yield a three dimensional model of the stationary scene containing the objects, wherein the analyzing is based at least partially on depth differences associated with the objects, and derived from the reflected distortions,
wherein the specified pattern comprises at least one of: spatial modulation and temporal modulation.

2. The method according to claim 1, further comprising detecting or tracking at least one object by repeating the illuminating with the specified pattern comprising spatial or spatiotemporal modulation, repeating the capturing, and analyzing the reflected distortions over time based on a comparison to stationary data derived from the three dimensional model.

3. The method according to claim 1, further comprising classifying at least one object by repeating the illuminating with the specified pattern comprising spatial or spatiotemporal modulation, repeating the capturing, and analyzing the reflected distortions by comparing geometrical features associated with the reflected distortion to respective geometrical features of other objects based on comparison to stationary data derived from the three dimensional model.

4. The method according to claim 1, wherein the illuminating and capturing further comprises illuminating and capturing in visible or non visible spectral band wherein the illuminating source is at least one of: gated and non-gated light source.

5. The method according to claims 1-3, wherein the specified pattern comprises a specified coding.

6. The method according to claims 1-3, wherein the specified pattern is un-coded, and the method further comprises checking the reflection of the specified pattern for continuity and uniformity.

7. The method according to claim 2 or 3, wherein the spatial or spatiotemporal modulation comprises a grid or a mesh.

8. The method according to claims 1-3, wherein the illuminating and the capturing are each carried out along two or more angles.

9. The method according to claim 8, wherein the analyzing is carried out stereoscopically using the specified pattern to align common objects from different angles.

10. A video capturing system comprising:
at least one light source arranged to illuminate an outdoor scene containing objects, with a structured light exhibiting a specified pattern, at a first angle;
at least one imaging device arranged to capture reflections from the objects in the scene, in a second angle, the reflections exhibiting distortions of the specified pattern; and
a data processing module arranged to analyze the reflected distortions of the specified pattern, to yield a three dimensional model of the stationary scene containing the objects wherein the analysis is based at least partially on depth differences associated with the objects, derived from the reflected distortions,
wherein the specified pattern comprises at least one of: temporal and spatial modulation.

11. The system according to claim 10, wherein the light sources are further arranged to repeat the illuminating with the specified pattern comprising spatial or spatiotemporal modulation, wherein the imaging devices are arranged to repeat the capturing, and wherein the data processing module is further arranged to analyze the reflected distortions over time, based on a comparison to stationary data derived from the three dimensional model, to yield detection or tracking of non-stationary objects in the scene.

12. The system according to claim 10, wherein the light sources are further arranged to repeat the illuminating with the specified pattern comprising spatial or spatiotemporal modulation, wherein the imaging devices are arranged to repeat the capturing, and wherein the data processing module is further arranged to analyze the reflected distortions by comparing geometrical features associated with the reflected distortion to respective geometrical features of other objects based on a comparison to stationary data derived from the three dimensional model, to yield classification of objects in the scene.

13. The system according to claim 10, wherein the illuminating and capturing further comprises illuminating and capturing in at least one of: visible and gated light respectively.

14. The system according to claims 10-13, wherein the specified pattern comprises a specified coding.

15. The system according to claims 11-13, wherein the specified pattern is un-coded, and the data processing system is further arranged to check the reflection of the specified pattern for continuity and uniformity.

16. The system according to claim 12 or 13, wherein the spatial or spatiotemporal modulation comprises a grid or a mesh.

17. The system according to claims 11-13, wherein the light sources and the imaging devices are illuminating and capturing along two or more angels respectively.

18. The system according to claim 17, wherein the data processing module is further arranged to carry out the analysis stereoscopically using the specified pattern to align common objects from different angles.

19. The system according to claims 10-13, wherein the structured light is infra red laser within short wave eye-safe range.

20. The system according to claim 19, wherein the infra red laser's wave length is within the Near Infra-Red (NIR) spectral band varying from approximately 0.7 μm to 1.1 μm.

21. The system according to claim 19, wherein the infra red laser's wave length is within the Short Wave Infra-Red (SWIR) spectral band varying from approximately 1.1 μm to 2.5 μm.

22. The system according to claim 10, further comprising a pan/tilt/zoom (PTZ) module in operative association with the at least one light source, wherein the PTZ module is configured to:
(i) aim the light source towards a specified target selected from the objects within the scene, in response to a user selection and
(ii) focus the pattern of the structured light projected upon the specified target.
